(19) United States
(12) Patent Application Publication
(10) Pub. No.: US 2026/0215361 A1
(43) Pub. Date: Jul. 30, 2026

(54) Rake/Vacuum Apparatus

(71) Applicant: Cody Mathew Williams, Birmingham, MI (US)

(72) Inventor: Cody Mathew Williams, Birmingham, MI (US)

(21) Appl. No.: 19/639,033

(22) Filed: Apr. 3, 2026

Related U.S. Application Data
(63) Continuation-in-part of application No. 18/418,960, filed on Jan. 22, 2024, now Pat. No. 12,622,368.

(51) Int. Cl. A01D 11/06; A01D 7/04; A01G 20/47

(52) U.S. Cl. CPC A01D 11/06; A01D 7/04; A01G 20/47

(57) ABSTRACT

A combination rake/refuse collector has a rake portion which collects leaves and other debris, and a handle portion with a hollow tube which holsters a rechargeable battery, and contains a mulching impeller, power switch and removable mulch-storage container. The mulching impeller sucks leaves collected by the rake portion through the hollow rake head and intake tube where they are shredded by the mulching impeller and exhausted into the attached mulch-storage container. The handle portion has motor cooling vents in its side to keep the electric battery-powered motor cool. The removable mulch storage container has small holes on its sides to allow exhaust air to exit to continue vacuum pressure, leaving mulched leaves inside. The invention moves all the parts the prior art of a rake/vacuum attached to a backpack containing the mulching impeller and storage bag, into a single, lightweight stand-alone battery-powered rake.

### CROSS REFERENCE TO RELATED APPLICATIONS

This utility patent application claims priority back to U.S. Utility Ser. No. 18/418,960, filed Jan. 22, 2024, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of devices for collecting leaves and other debris, then mulching and disposing of them, and more specifically toward a combination rake/vacuum apparatus that has both the mulching and storage portions of the invention in the rake handle as opposed to the external storage seen in some of the prior art.

### Statement of the Problem Solved

How to collect fallen leaves off a lawn or other part of a person's property has been a problem facing property owners for centuries. A more recent problem has arisen in stadiums and arenas where patrons purchase food and drinks in paper and plastic wrappers and cups, and the leave their debris, along with peanut shells, partially eaten food, popcorn, confetti and other debris under the stadium seats.

### Prior Art

There is considerable prior art that attempts to collect leaves on a lawn. There are simple rakes, which require a user to physically contain the leaves (usually with one hand pressing the leaves against the rake) and lifting them into a trash can or other container. There are also motorized lawn tractors that can suck up cut grass and could be used to remove and store leaves, but these are expensive and not good for fine-tuned leaf cleanup.

U.S. Pat. No. 9,961,838 to Horth describes a lawn debris collection assembly having a plenum assembly configured to be positioned in close proximate relationship with a lawn surface having lawn debris lodged between lawn blades of a lawn. The plenum assembly is movable along the lawn surface and configured to house a positive air-pressure stream in such a way that the positive air-pressure stream is directed toward the lawn debris, and the positive air-pressure stream, in use, dislodges the lawn debris from between the lawn blades. The plenum assembly is also configured to house a negative air-pressure airstream in such a way that the negative air-pressure airstream, in use, flows from the plenum assembly to a debris-collection bag. The negative air-pressure airstream, in use, urges the lawn debris to move from the plenum assembly to the debris-collection bag. This device is quite complicated and is basically a vacuum cleaner at the end of a pole.

An equally cumbersome device is found in US 20160066513 to Gray, and U.S. Pat. No. 8,266,763 to Hays requires a large bag and an unwieldy suction device.

U.S. Pat. No. 7,814,615 to Ries is a patent that covers a blower attachment to a rake, which creates an air stream generated by air stream generating device to be directed into a loosely defined plane. The raking attachment comprises a generally triangular shaped top wall, an opposing triangular shaped bottom face, side walls and an inlet throat with the side walls joined to at least a portion of the top wall and the bottom face wherein the top wall, bottom face and side walls extend longitudinally from the inlet throat. The top wall also extends beyond a terminal end of the bottom face and terminates in an end wall that is disposed at an angle relative to the top wall. However, this invention does not have the capacity to pick up the leaves and dispose of them.

U.S. Pat. No. 8,266,763 to Hays describes a leaf and lawn vacuum bagger, however this invention does not provide a backpack and lacks a rake or vacuum and also fails to provide a biodegradable paper bag for leaf storage. U.S. Pat. No. 9,364,125 to Makita provides a backpack power apparatus but fails to have a rake, a vacuum and also does not provide a leaf bag. CN 212175647 teaches another backpack-style leaf cleaning device, but this invention fails to provide a rake or vacuum, and there is no bag for disposal of leaves.

US Publication 2023-0122554 to Williams describes a vacuum rake which sucks up leaves and other debris, and deposits them into a backpack which includes a mulcher and a mulched debris container. This invention, however, requires a backpack to carry both the mulching and the storage parts of the invention. The current invention takes the vacuum rake and attached backpack, which contained the mulching impeller and storage bag, and moves all the parts into a single rake. This makes the job of collecting and mulching leaves and other debris easier, as the user needs only to grab a rake and start vacuuming up the leaves, and when the collection bag is full, the user does not need to remove his/her backpack to access the collection bag.

However, none of the prior art offers an easy way for a person to collect leaves and other debris from a lawn in an effective manner without requiring a large and expensive vehicle such as a lawn tractor, or to require the person to carry about a backpack in which both the mulching and the storage portions of the invention are stored. The current invention provides a solution by combing a rake and a vacuum in a novel manner. The invention provided is a combination rake/refuse collector that has a rake portion which traps leaves and other debris, a handle portion which contains a hollow tube, and a connector portion which connects the hollow tube to a vacuum unit/mulching impeller located within the rake handle. The shredding impeller redirects air from a vacuum intake, through the shredding impeller, and eventually into to a storage bag with holes in the side which allow the exhaust air to leave the device but leave the mulched debris inside in a mulch container. With both the mulching impeller and the mulch container located either inside the rake handle, or attached directly outside the rake handle, the invention allows a user to easily vacuum up leaves and mulch them, without having to use any external machines or storage containers.

The handle portion allows the user to direct the rake portion toward a bunch of leaves or other debris. The rake tines serve to flip the leaves up and back toward the vacuum intake, where it sucks them up. The bag is easily and quickly removable from the rake handle, thereby facilitating easy and efficient disposal of leaves. The shredding impeller is powered by a battery that is contained in a battery compartment on the outer surface of the unit, thereby allowing for easy and quick replacement of the rechargeable battery. The shredding impeller can be made from a number of products, including plastic, nylon and metal. It can be removed from the rake handle housing by a professional for replacement or sharpening.

In a particularly preferred embodiment, there is an aluminum alloy debris shredding impeller, and a rake with a width of 24″, such that entire lawns can be raked easily and quickly, as opposed to the small, 8″ rakes that are currently in use. The device can be designed to allow for interchangeable rake heads.

In a separate embodiment, the device has the handle portion removable from the connector portion through a quick-connect, then attached to the exhaust port to turn the leaf collector into a leaf blower. In this embodiment, the rake heads can be removed to allow the blast of air from the fan to blow the leaves.

By way of a basic description of the function of one embodiment of the invention, the leaves are collected with the tines of the leaf rake that flip the leaves up and back towards the Vacuum intake device that's incorporated into the underside of the Leaf Rake. The leaves are then sucked up into the Leaf Rake Handle which is also a hollow tube. The suction is created by a mulching impeller located in the rake handle. The mulching impeller mulches the leaves or other debris as they pass through the blades. The suction to the mulching impeller also results in an air flow behind the mulching impeller, which forces the mulched leaves and other debris into a mulch storage device, which a removable connected externally to the rake handle. The storage device can be clear plastic or a nylon bag, both with numerous small holes on the side through which the exhaust air can escape, but are too fine to allow any of the mulched debris to escape.

In a particularly preferred embodiment, the leaf collection device is 100% Recyclable, Biodegradable, Compostable, and Disposable. In another embodiment, the bag can hold both wet and dry debris. Once the debris collection bag is filled with debris, a user can momentarily turn off the power switch and the bag can be easily removed from rake handle and either placed at the curb for trash pickup, set into a compost pile, or burned, and a new debris collection bag attached.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a perspective view of the rake/vacuum apparatus as being used by a person to rake/vacuum up leaves.

FIG. 2 is a perspective view of the rake/vacuum apparatus.

FIG. 3 is a perspective, cut-away view of the mulching portion of the rake/vacuum apparatus.

FIG. 4 is a perspective view of the handle portion of the apparatus.

FIG. 5 is a perspective view of the collection container portion of the invention.

FIG. 6 is a perspective view of the battery housing portion of the invention.

FIG. 7 is a perspective view of a second embodiment of the invention with a nylon bag instead of the clear, plastic container to collect the mulched debris..

FIG. 8 is a perspective view of the rack and handle portion of this second embodiment of the invention.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

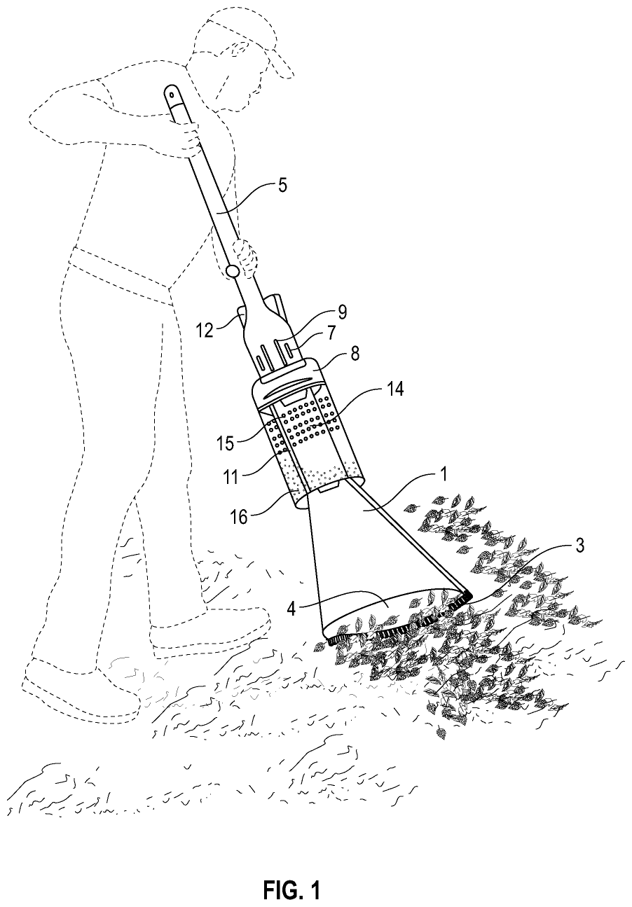

FIG. 1 is a perspective view of the rake/vacuum apparatus as being used by a person to rake/vacuum up leaves. The device has a rake portion 1 and a handle portion 5. The rake portion 1 has a number of tines 3 which are used to collect the leaves or debris. The rake head 2 is larger on the side near that tines 3 and funnels back to a vacuum intake section 4, which is basically a hollow tube extending down from the rake handle 5. The rake handle 5 has a narrow upper section that can be comfortably gripped by a person using the invention. Further down the rake handle 5 is a motor housing 7 and houses the electric motor (19 in other figures). The motor housing 7 has several motor cooling vents 9 that keep the motor cool during use. The basic function has the electric motor generating a suction force that pulls leaves and other debris up the vacuum intake 4, through a leaf intake tube 14 and into a shredding impeller (28 in other figures), where they are mulched. The shredding impeller not only “pulls” the leaves and other debris up to it, but also forces the mulched debris and exhaust air away from the shredding impeller. The mulched debris 16 end up in a removable leaf/vacuum container 11, which has numerous vent holes for exhaust air 15. When the removable leaf/vacuum container 11 gets full, it is easily removed from the mulching impeller case 8, emptied, and replaced. A battery 12 in a battery housing 13 provided the power to turn the mulching impeller, controlled by an On/Off switch 6 on the handle portion 5.

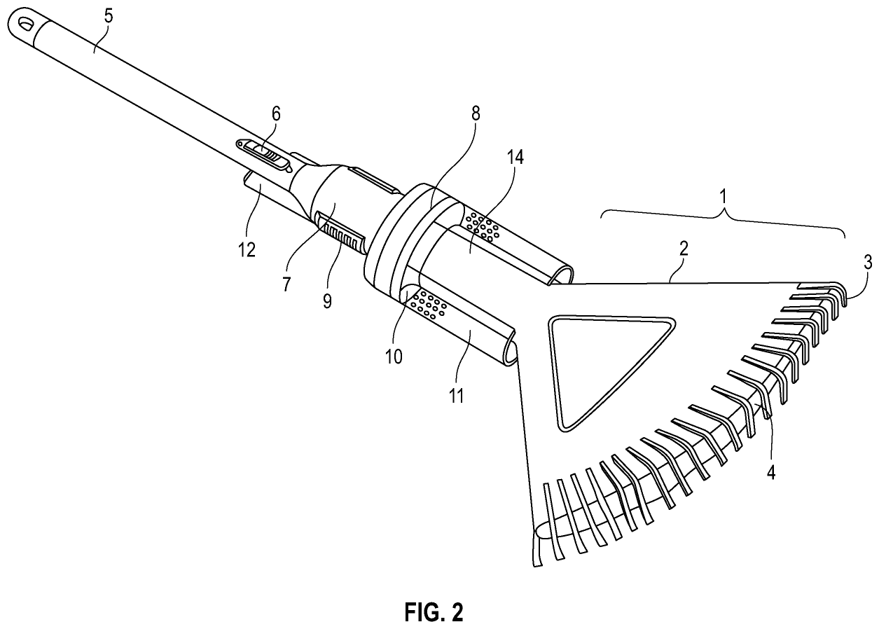

FIG. 2 is a perspective view of the rake/vacuum apparatus. The rake portion 1 comprises a rake head 2 with tines 3, which are used to direct the leaves to the vacuum intake 4. The leaves and debris are “pulled up” by a shredding impeller (28 in other figures), which chops up the leaves and debris and turns them into mulch. An exhaust port 10 behind the mulching impeller directs the mulch into a removable leaf container 11 housed in a mulching impeller case 8. In this case, the removable leaf container is a clear plastic mulch container 20.

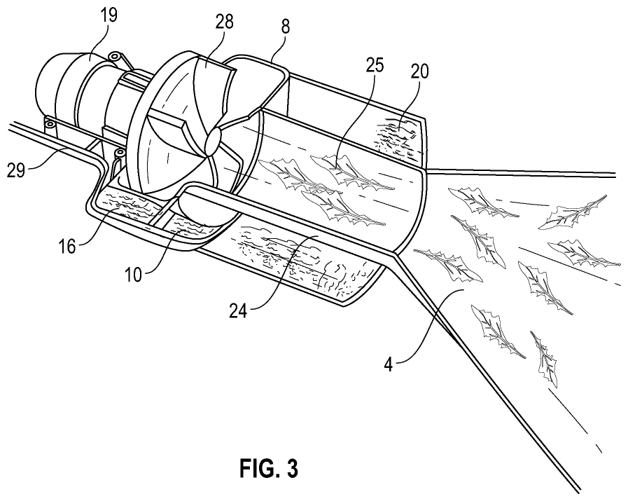

FIG. 3 is a perspective, cut-away view of the mulching portion of the rake/vacuum apparatus. A shredding impeller 28 is held inside an impeller case 8 and powered by an electric motor 19 held inside a motor housing 7. The electric motor 19 is powered by a battery and controlled by an On/Off Switch. Coming off the electric motor 19 are a battery wire 18 and an On/Off Switch wire 17. The unmulched debris 25 are pulled through an intake tube 24 an into the shredding impeller 28 by the vacuum created by the shredding impeller rotating, where they are shredded into mulched debris 16. After the leaves and other debris are shredded by the shredding impeller 28, an air flow pushes the mulched debris 16 through an exhaust port from the impeller case 26 where they collect in the, in this embodiment, the clear plastic mulch container 20.

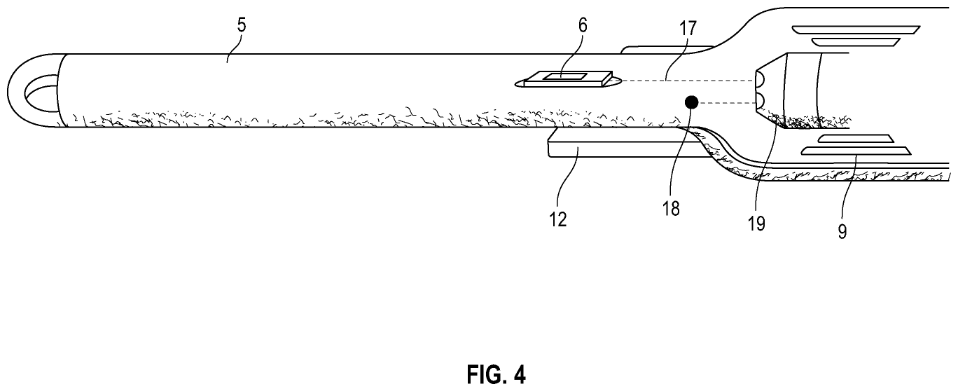

FIG. 4 is a perspective view of the handle portion 5 of the apparatus. The upper portion of the rake handle is a hollow tube with a narrow enough circumference to be comfortably held by a person. Further down the handle portion is an On/Off switch 6, which allows or prevents electrical current from the battery 12 to each the electric motor.

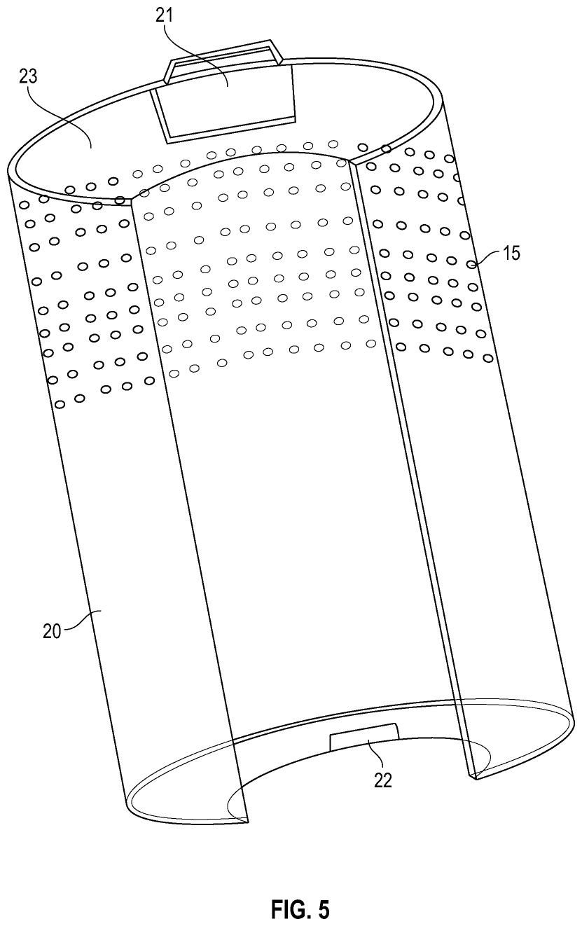

FIG. 5 is a perspective view of the collection container portion 11 of the invention. In this embodiment, the collection container is a clear plastic mulch container 20. It has an open top 23 to receive mulch from the shredding impeller, a push-button release 21 which allows it to snap on and off easily to empty it, a notch 22 that allows it to set into the rake head. There are also numerous small vent holes for exhaust air 15 that allow the exhaust air to escape while trapping the mulched debris.

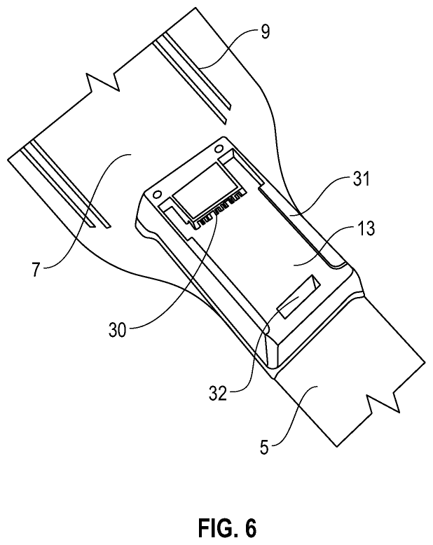

FIG. 6 is a perspective view of the battery housing portion of the invention. The battery housing 13 is attached to the rake handle portion 5 of the invention. It has slide rails 31 which allow the battery to be easily attachable and detachable. A series of terminal blocks provide connectivity between the battery and the On/Off Switch and the electric motor. There is a slot 32 into which the battery (12 in other figures) has a spring-loaded latch can lock into.

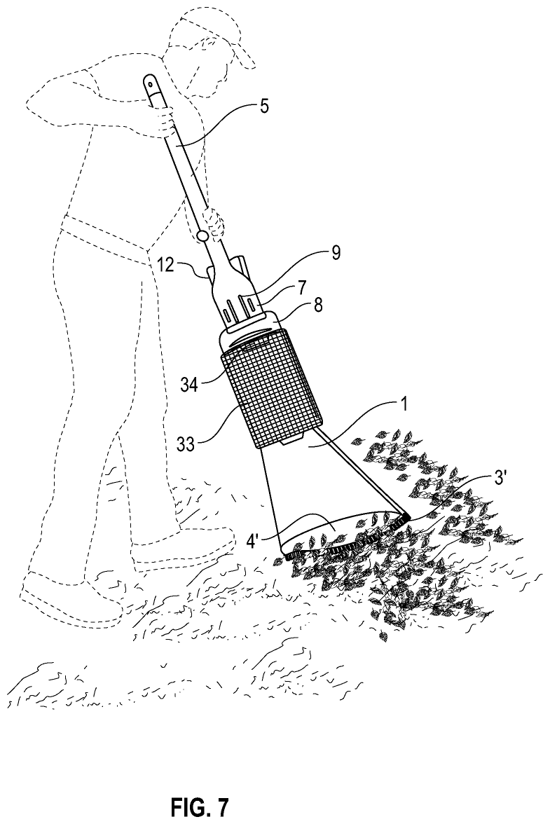

FIG. 7 is a perspective view of a second embodiment of the invention with a nylon bag instead of the clear, plastic container to collect the mulched debris. The device has a rake portion 1 and a handle portion 5. The rake portion 1 has a number of tines 3 which are used to collect the leaves or debris. The rake head 2 is larger on the side near that tines 3 and funnels back to a vacuum intake section 4, which is basically a hollow tube extending down from the rake handle 5. The rake handle 5 has a narrow upper section that can be comfortably gripped by a person using the invention. Further down the rake handle 5 is a motor housing 7 and houses the electric motor (19 in other figures). The motor housing 7 has several motor cooling vents 9 that keep the motor cool during use. The basic function has the electric motor generating a suction force that pulls leaves and other debris up the vacuum intake 4, through a leaf intake tube 14 and into a shredding impeller (28 in other figures), where they are mulched. The shredding impeller not only “pulls” the leaves and other debris up to it, but also forces the mulched debris and exhaust air away from the shredding impeller. The mulched debris 16 end up in a removable leaf/vacuum container which in this embodiment is a nylon bag 33. When the removable leaf/vacuum container, in this case a nylon bag 33, gets full, it is easily removed from the mulching impeller case 8, emptied, and replaced. A battery 12 in a battery housing 13 provided the power to turn the mulching impeller, controlled by an On/Off switch 6 on the handle portion 5.

In a particularly preferred embodiment, the nylon bag 33 is made from Oxford Cloth, which is a polyester/nylon blend with a 420D to 600D hole size. Oxford Cloth is durable, waterproof, and designed for high airflow situations. It is tear-resistant, which allows it to handle abrasion from the sharp edges of leaves, twigs and other debris as they are forced against the side of the nylon bag 33. This note regarding Oxford Cloth is not meant to be limiting, as virtually any material that has small holes through which exhaust air can pass but mulch cannot pass could be used.

It should also be noted that the structure of the Oxford Cloth bag allows the bag to easily snap on and off the rake with a simple push button. This allows the user to turn the bag upside down to empty it without the bag collapsing.

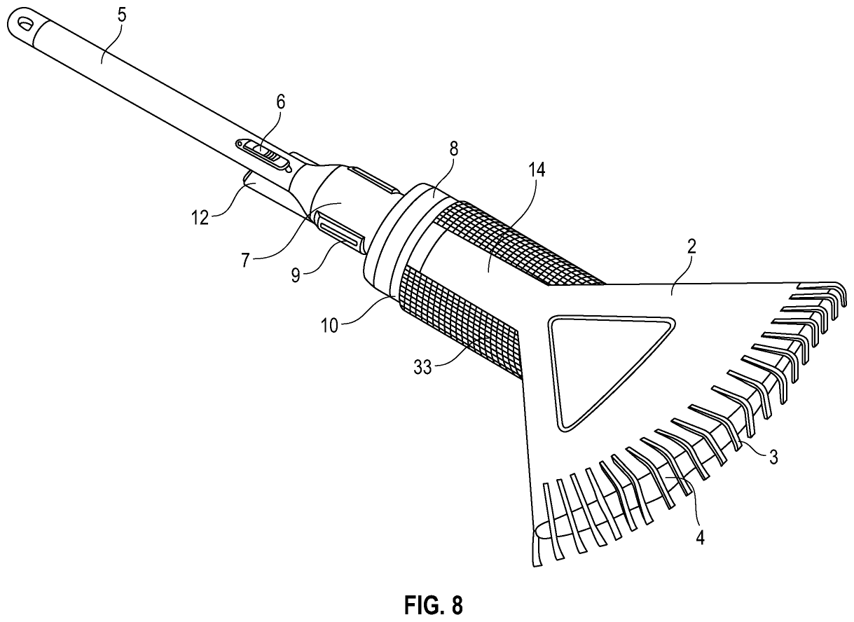

FIG. 8 is a perspective view of the rack and handle portion of this second embodiment of the invention. The rake portion 1 comprises a rake head 2 with tines 3, which are used to direct the leaves to the vacuum intake 4. The leaves and debris are “pulled up” by a shredding impeller (28 in other figures), which chops up the leaves and debris and turns them into mulch. An exhaust port 10 behind the mulching impeller directs the mulch into a removable leaf container 11 housed in a mulching impeller case 8. In this case, the removable leaf container is a bag 33 with a quick-release 34 which allows for a user to quickly and easily remove full bags, empty, and replace. The nylon bag 33, preferable of Oxford Cloth, is a mesh bag that allow the exhaust air to easily escape, leaving behind the mulched debris.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### Reference Numbers Used

1. Rake portion.
2. Rake Head
3. Tines
4. Vacuum intake
5. Handle portion.
6. On/Off Switch
7. Motor housing portion
8. Mulching impeller case
9. Motor cooling vents
10.Exit Port for exhaust air and mulch
11.Removable Leaf/Vacuum container
12.Battery
13.Battery housing
14.Leaf Intake Tube
15.Vent holes for exhaust air
16.Mulched debris.
17.Power switch connected to motor line.
18.Battery wire connected to motor.
19.Electric motor
20.Clear plastic mulch container.
21.Push-button release
22.Notch sets into rake head.
23.Open top to received mulch and easy empty
24.Intake tube
25.Unmulched debris
26.Exhaust port from Impeller case.
27. Left blank intentionally
28.Shredding impeller
29.Rake Handle tube.
30.Battery terminal blocks
31.Battery slide rails
32.Battery slot
33.Nylon bag (removable), preferably Oxford Cloth
34.Nylon bag quick release

What i claim is:

1. A device for collecting and processing debris, consisting of a rake portion and a handle portion,
wherein the rake portion consists of a rake head which has at an upper end a vacuum intake, and at a lower end, a plurality of tines, wherein the lower end is substantially wider than the upper end, wherein the tines collect leaves and other debris and funnel these to the vacuum intake,
wherein the handle portion consists of a hollow tube upper section which is gripped by a user, a motor housing, which houses an electric motor, wherein the electric motor is powered by a battery, a mulching impeller case, which houses a shredding impeller, an On/Off Switch, and a battery housing,
wherein the shredding impeller creates a vacuum, which forces the leaves and other debris through the vacuum intake, up a leaf intake tube, and through the shredding impeller, wherein the leaves and other debris are shredded into a quantity of mulch,
where in the shredding impeller also creates an airflow which forces the quantity of mulch through an exit port and into a removable leaf/vacuum container.

2. The device of claim 1, wherein the removable leaf/vacuum container is attached to the rake handle portion of the invention.

3. The device of claim 2, wherein the removable leaf/vacuum container has a quick-release mechanism for a quick and efficient replacement of a full leaf/vacuum container with an empty leaf/vacuum container.

4. The device of claim 3, wherein the removable leaf/vacuum container has a plurality of small holes through which air can pass but the quantity of mulch cannot pass, thereby trapping the quantity of mulch in the removable leaf/vacuum container.

5. The device of claim 4, additionally comprising a battery housing, wherein the battery housing a power switch line that connects and disconnects the battery from the electric motor.

6. The device of claim 5, wherein the removable leaf/vacuum container is a clear plastic container.

7. The device of claim 5, wherein the removable leaf/vacuum container is a nylon bag, wherein, the nylon bag is made from Oxford Cloth, with a hole size that is within the range 420D to 600D hole size.

8. A device for collecting and processing debris, comprising a rake portion and a handle portion,
wherein the rake portion comprises a rake head which has at an upper end a vacuum intake, and at a lower end, a plurality of tines, wherein the lower end is substantially wider than the upper end, wherein the tines collect leaves and other debris and funnel these to the vacuum intake,
wherein the handle portion comprises a hollow tube upper section which is gripped by a user, a motor housing, which houses an electric motor, wherein the electric motor is powered by a battery, a mulching impeller case, which houses a shredding impeller, an On/Off Switch, and a battery housing,
wherein the leaves and other debris are shredded by the shredding impeller into a quantity of mulch, and wherein the mulch is collected in a removable leaf/vacuum container.

9. The device of claim 8, wherein the removable leaf/vacuum container is attached to the rake handle portion of the invention.

10. The device of claim 8, wherein the shredding impeller creates a vacuum, which forces the leaves and other debris through the vacuum intake, up a leaf intake tube, and through the shredding impeller, wherein the leaves and other debris are shredded into a quantity of mulch.

11. The device of claim 10, wherein the shredding impeller also creates an airflow which forces the quantity of mulch through an exit port and into a removable leaf/vacuum container.

12. The device of claim 11, wherein the removable leaf/vacuum container is attached to the rake handle portion of the invention.

13. The device of claim 12, wherein the removable leaf/vacuum container has a quick-release mechanism for a quick and efficient replacement of a full leaf/vacuum container with an empty leaf/vacuum container.

14. The device of claim 13, wherein the removable leaf/vacuum container has a plurality of small holes through which air can pass but the quantity of mulch cannot pass, thereby trapping the quantity of mulch in the removable leaf/vacuum container.

15. The device of claim 14, additionally comprising a battery housing, wherein the battery housing a power switch line that connects and disconnects the battery from the electric motor.

16. The device of claim 15, wherein the removable leaf/vacuum container is a clear plastic container.

17. The device of claim 15, wherein the removable leaf/vacuum container is a nylon bag.

18. The device of claim 17, wherein the nylon bag is made from Oxford Cloth, with a hole size that is within the range 420D to 600D hole size.

19. A device for collecting and processing debris, comprising a rake portion and a handle portion,
wherein leaves and other debris are shredded by a shredding impeller, wherein the shredding impeller is located within the handle portion, wherein the leaves and other debris are shredded by the shredding impeller into a quantity of mulch, and wherein the mulch is collected in a removable leaf/vacuum container, wherein the rake portion comprises a rake head which has at an upper end a vacuum intake, and at a lower end, a plurality of tines, wherein the lower end is substantially wider than the upper end, wherein the tines collect leaves and other debris and funnel these to the vacuum intake,
wherein the handle portion comprises a hollow tube upper section which is gripped by a user, a motor housing, which houses an electric motor, wherein the electric motor is powered by a battery, a mulching impeller case, which houses a shredding impeller, an On/Off Switch, and a battery housing, wherein the removable leaf/vacuum container is attached to the rake handle portion of the invention, wherein the shredding impeller creates a vacuum, which forces the leaves and other debris through the vacuum intake, up a leaf intake tube, and through the shredding impeller, wherein the leaves and other debris are shredded into a quantity of mulch, wherein the shredding impeller also creates an airflow which forces the quantity of mulch through an exit port and into a removable leaf/vacuum container, wherein the removable leaf/vacuum container has a quick-release mechanism for a quick and efficient replacement of a full leaf/vacuum container with an empty leaf/vacuum container, wherein the removable leaf/vacuum container has a plurality of small holes through which air can pass but the quantity of mulch cannot pass, thereby trapping the quantity of mulch in the removable leaf/vacuum container, additionally comprising a battery housing, wherein the battery housing a power switch line that connects and disconnects the battery from the electric motor.

20. The device of claim 19, wherein the removable leaf/vacuum container is a nylon bag, wherein the nylon bag is made from Oxford Cloth, with a hole size that is within the range 420D to 600D hole size.
